(19) United States
(12) Patent Application Publication
(10) Pub. No.: US 2015/0355479 A1
(43) Pub. Date: Dec. 10, 2015

(54) SPECTACLE FRAME HAVING TELESCOPIC HINGES WITH AN ADJUSTABLE OFFSET SPRING, MOUNTED IN A ROTARY END PIECE

(71) Applicants: Richard CHENE, Neuilly (FR); Dominique DELAMOUR, Les Mesnuls (FR); Alain MIKLITARIAN, Paris (FR)

(72) Inventors: Richard CHENE, Neuilly (FR); Dominique DELAMOUR, Les Mesnuls (FR); Alain MIKLITARIAN, Paris (FR)

(21) Appl. No.: 14/760,782

(22) PCT Filed: Jan. 15, 2014
(86) PCT No.: PCT/EP2014/050703

§ 371 Date: Jul. 14, 2015

(30) Foreign Application Priority Data
Jan. 17, 2013 (FR) 1350423

(51) Int. Cl. G02C 5/22; G02C 5/14

(52) U.S. Cl. CPC G02C 5/2236; G02C 5/143; G02C 2200/26

(57) ABSTRACT

The invention relates to a spectacle frame having two temples that are articulated by two telescopic hinges, each with a front face element and a temple element, which has a slide (123) articulated to the front face element and mounted so as to slide in a sheath (125) counter to and under the action of a spring (126). The slide (123) extends as far as the free end of the temple (15) that provides said sheath (125). A sleeve (130), mounted on the slide (123), slides in the end of the temple in which said spring (126) also extends. The temple is produced in two parts, namely a main part (115) and an end that forms an end piece (117) in which the spring (126) is disposed. The end piece (117) is mounted so as to be able to rotate with respect to the main temple part (115) in order to adjust the tension in the spring (126).

The field of the invention is that of spectacle frames.

A spectacle frame comprises a front face and two temples mounted so as to each be articulated on a lateral lug of the front face by means of a hinge.

In the open position, a spectacle temple extends substantially at a right angle to the overall plane of the front face.

A telescopic hinge makes it possible to open the temple beyond this right angle. By means of this “over-opening”, said hinge provides greater comfort when the frame is placed on the nose and avoids the risk of breaking or deforming the frame and temples.

A telescopic spectacle frame hinge generally comprises a spring that presses the temple against the head but specifically allows over-opening.

A telescopic hinge generally comprises two elements assembled on an articulation spindle and rigidly connected to a front-face lug (a face element) and a temple (a temple element) respectively, and more particularly to the tang of the temple, which is the web on which it is formed, when this web does not form the temple itself. It may also be that the hinge is fixed directly to the temple, even when said temple is provided with a tang, the attachment taking place on the end of the temple, which is also referred to as the temple lug.

The temple element which is rigidly connected to the temple comprises a slide which is mounted firstly on the articulation spindle and secondly in a sheath which is rigidly connected to the web or to the temple itself. The slide is slid into the sheath counter to and under the action of a spring, generally a compression spring, also extending into the sheath.

In frames of the type mentioned above, the temple hinges, because of the presence of the spring, are therefore fairly bulky and heavy. In addition, and again because of this, the temples, at the hinges, are fairly thick. All this contributes to making the frames heavy in the region of the front face, which is not conducive to comfort, in particular for the nose of the user, which becomes marked by the bridge that joins the two parts of the front face supporting the lenses.

FR 2962560 discloses a spectacle frame comprising a front face which is extended by two lateral lugs and two temples which are each articulated on the lugs about articulation spindles of two telescopic hinges, to a front face element which is rigidly connected to a lug and a temple element which is rigidly connected to a temple, the temple element of a hinge comprising a slide which is articulated on the front face element and which is mounted so as to slide in a sheath counter to and under the action of at least one spring, the slide of a temple hinge extending as far as the free end of the tubular temple housing said sheath, a sleeve, mounted on the slide, being slidably mounted in the end of the temple, in which said spring also extends so as to cooperate with the sleeve.

With such a spectacle frame, the hinge spring being offset in the free end of the temple, part of the mass that was situated at the front, in the hinge, is transferred to the rear, in the end of the temple, which relieves the nose of the user and improves comfort.

To adjust the tension of the spring—the hinge spring that has become the temple spring—it is necessary to consult an optician having available the appropriate tool for this purpose, unless the wearer of the frame has one. In any event, a separate tool is essential.

The problem addressed by the applicants is that of allowing the wearer of the frame to adjust the tension of the spring himself without the aid of any tool.

For this purpose, the invention relates to a spectacle frame of the type specified above, characterised by the fact that the temple is produced in two separate parts, a main part and an end part which forms an end piece in which the spring is arranged, the slide extending into the end piece, which is mounted so as to rotate with respect to the main temple part in order to adjust the tension of the spring.

Thus, by virtue of the invention, the wearer of the spectacle frame can adjust it in line with his expectations or his activities, tensioning or relieving the tension from the spring as suits him by rotating the end piece.

It should be noted that the temple end piece may have the form of a spatula, as is often the case with a temple end.

Since the two parts of the temple are separate, if only for reasons of manufacturing precision, they are spaced apart from each other.

The applicants were compelled to keep the separation of the two parts of the temple as small and constant as possible. Indeed, in wishing to avoid the rotation of the end piece increasing or reducing this separation, the wearer of the frame avoids the risk of jamming his hair therein. Dirtying the space between the two parts is also avoided in this way.

Thus the two parts of the temple of the frame of the invention are preferably both mounted on the same intermediate core which is fixed in translation, with respect to the main temple part, in the main temple part, the end piece being mounted so as to be able to rotate freely on the core which serves as a translation stop for said end piece.

Preferably, a ring, which is arranged in the end piece to which it is fixed for conjoint rotation and translation therewith, comes into abutment against the core, the sleeve, which is mounted so as to be able to slide in translation in the end piece, also being arranged so as to slide in translation on the ring.

In the preferred embodiment of the frame of the invention, the spring is housed in the sleeve, in abutment at one end against the bottom of a bore which is formed in the sleeve, and, at the other end, against the ring, the sleeve and the slide passing through the core, the ring and the spring cooperating by screwing.

Thus, and in order to give a clear understanding, when the end piece is turned, the sleeve also turns, for example in order to screw onto the slide, and the sleeve turns on the ring while moving in translation thereon, in order to move closer to the main temple part, which compresses the spring, but without the end piece moving closer to the main temple part because the ring is in abutment against the core.

Since the sleeve is preferably slidably mounted in the end piece, said sleeve can be arranged so as to slide along at least one groove or one rib in the end piece or ring.

In a variant of the frame of the invention, instead of the slide passing through a single adjustment spring, two adjustment springs are provided, which extend on either side of the slide, in order to increase the adjustment force.

The invention will be better understood with the help of the following description of several embodiments of the frame, with reference to the accompanying drawings, in which:

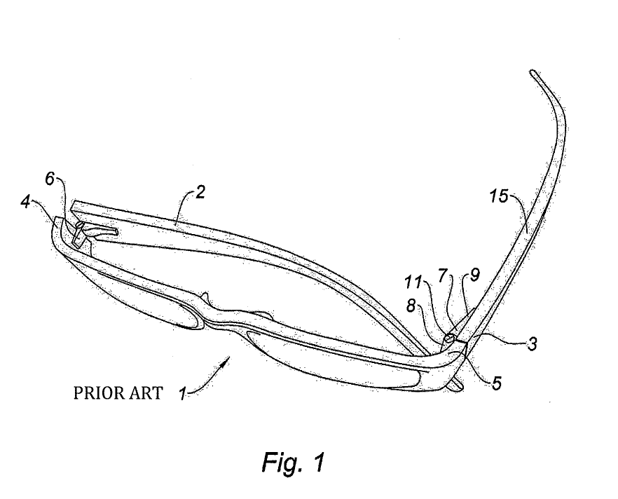

FIG. 1 is a perspective plan view of a conventional spectacle frame;

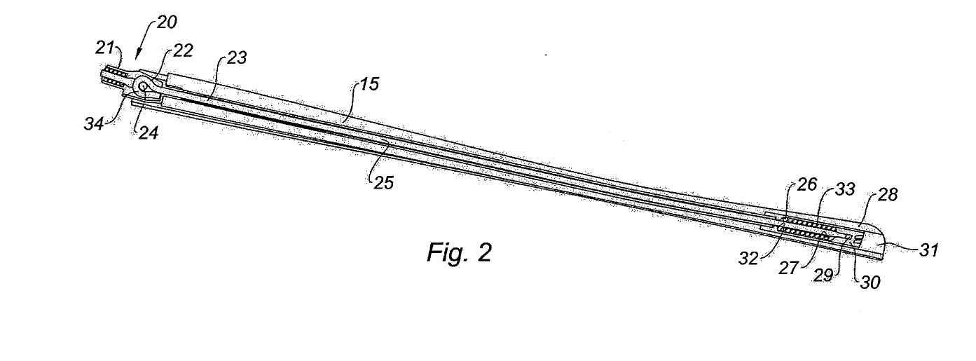

FIG. 2 is a cross section of one of the temples of the frame of the prior art which the applicants took as a starting point in order to propose their invention;

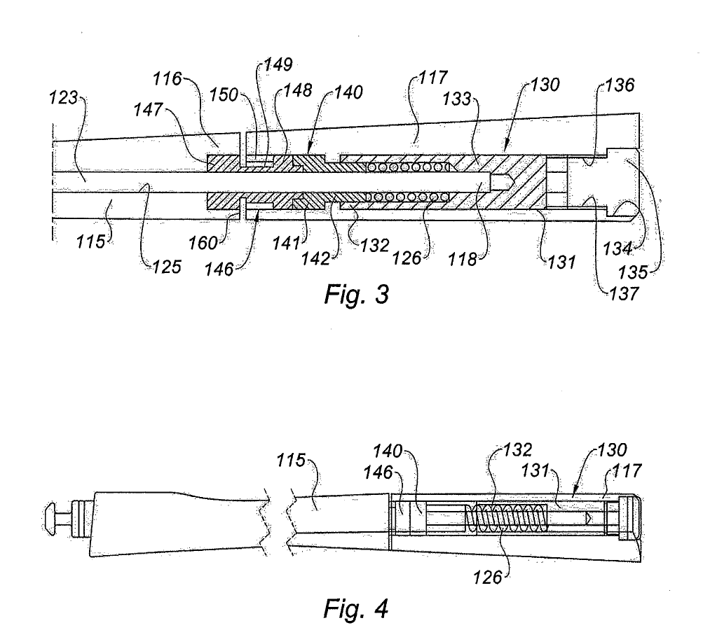

FIG. 3 is a cross section of the two temple parts of one of the temples of the frame of the invention;

FIG. 4 is a view similar to that of FIG. 3, before turning the end piece with respect to the main temple part;

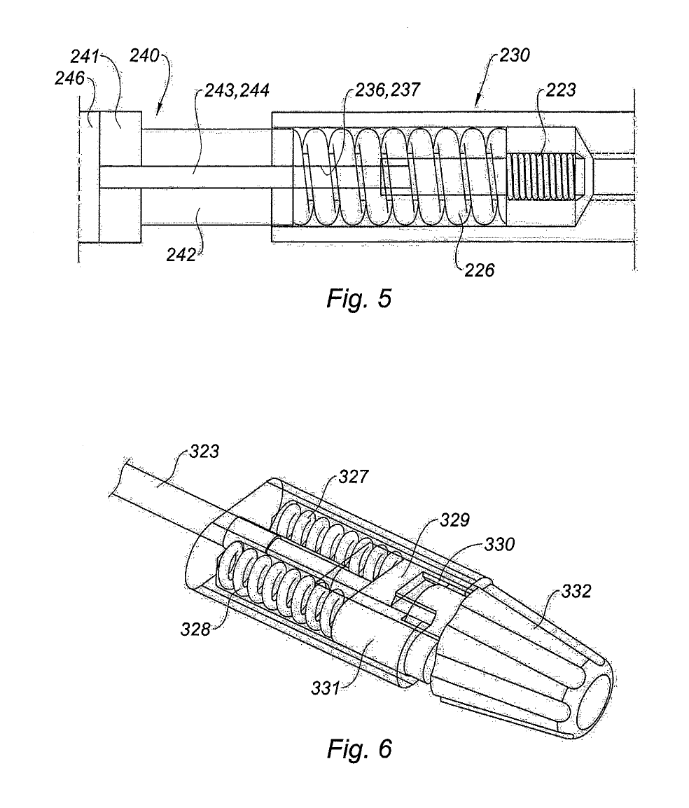

FIG. 5 is a transparent perspective view of the two temple parts of one of the temples of a variant of the frame of the invention, and

FIG. 6 is a transparent perspective view of the end piece of one of the temples of a second variant of the frame of the invention.

A conventional spectacle frame of the prior art comprises, with reference to FIG. 1, a front face 1 intended to receive lenses, which are generally optical, and a right temple 2 and a left temple 3, in the example shown, said right temple 2 being folded against the rear of the front face 1 in the closed position and said left temple 3 being in the open position substantially perpendicular to the overall plane of the front face 1. The front face 1 is extended laterally, substantially at a right angle, by two lateral front-face lugs 4, 5 on which the temples 2, 3 are articulated by means of two hinges 6, 7, here so-called telescopic hinges.

A telescopic hinge—that is to say for example the left hinge 7—comprises a front-face element 8 which is rigidly connected to the front-face lug 5, and a temple element 9 which is rigidly connected to the temple 3 and, more precisely here, to the web 15 of said temple on which it is formed. The two hinge elements are articulated on an articulation spindle 11 which is rigidly connected to the front-face element 8.

The hinges 6, 7 of the two temples 2, 3 are identical.

This having been set out, the temples of the frame improved by the invention of the present application will now be dealt with.

The two temples are still identical.

A temple 15 is articulated, at one end, on a lateral lug of the front face by means of a hinge 20, also referred to as telescopic, comprising a front-face element 21 which is rigidly connected to the lug, and a temple element 22 which is rigidly connected to the temple 15, comprising a slide 23 which is articulated on the front-face element 21 about an articulation spindle 24, and which is slidably mounted in a sheath 25 provided in the temple 15, which is therefore tubular.

The slide moves in the sheath 25 counter to and under the action of a spring 26 which is arranged at the other end 28 of the temple, referred to as the free end, in a broadened portion 27 of sheath 25.

The end 29 of the slide 23 is threaded and screwed into a tapped sleeve 30 closing off the sheath 25, 27, which extends as far as the edge of the temple end 28 which is closed off by a decorative plug 31.

The sleeve 30 is removable and therefore makes it possible to place a spring 26 which is adapted and suitable for the planned use according to its strength. Since it is accessible, the spring 26 can be replaced. The spring 26, which is a compression spring, is therefore housed in the broadened part 27 of the sheath 25 in abutment through the two ends thereof with the bottom 32 of said broadened part, on the one hand, and on the end face 33, which is turned towards the inside, of the sleeve 30.

At the time of the closure or over-opening pivoting of the temple, the slide 23 is driven into the sheath 25 in the direction of the free end 28 of the temple towards the hinge 20. The slide 23, in its movement, draws the sleeve 30 therewith, which compresses the spring 26.

In the idle state, with the temple closed or open, the spring 26 is expanded, after sliding of the slide 23 in the other direction under the action of the spring 26.

It should be noted that the end 34 of the slide 23 which is arranged in the hinge is in the form of a hook, or eye, in order to be able to turn about the articulation spindle 24.

The tension of the spring 26 cannot be adjusted by the wearer of the frame.

The frame of the invention that will now be described, in its various embodiments, having one or more adjustment springs, will allow its wearer to adjust this tension himself.

Each temple of the frame depicted in FIG. 1 is in two parts, a main part 115 and, extending it beyond the posterior end 116 thereof while being separated, an end piece 117.

In some embodiments of the frame, this end piece may be in the form of a spatula.

The anterior end of the main temple part 115 is entirely similar, functionally and structurally, to the anterior end of the temples 15 of the frame depicted in FIG. 2.

A sheath 125 is provided in the main temple part 115 and a slide 123 is slidably mounted therein. The slide 123 also extends into the end piece 117, beyond the posterior end 116 of the main temple part 115. The end 118 of the slide 123 is threaded. It is screwed into a sleeve 130 which is tapped for this purpose.

The sleeve 130 comprises, at the rear, a cylindrical barrel 131, which is therefore tapped, extended, at the front, by an annular skirt 132. The sleeve 130 is housed in a central through-bore 133 which is formed in the end piece 117. At its posterior end 134, the bore 133 of the end piece 117 is closed off by a decorative plug 135.

Here, the sleeve 130 is slidably mounted in the end piece 117. In the embodiment shown in FIG. 3, the barrel 131 of the sleeve here comprises two external longitudinal ribs (not shown), parallel to the axis of the temple and diametrically opposed, and which are engaged in two corresponding grooves 136, 137 which are formed in the wall of the bore 133 in the end piece 117.

Inside the skirt 132 of the sleeve 130, an adjustment spring 126 is housed, which is a compression spring here, and through which the portion of the slide 123 adjacent to the threaded end 118 thereof extends.

The end piece 117 is mounted so as to rotate with respect to the main temple part 115, in order to adjust the tension of the spring 126.

A ring 140 is mounted inside the bore 133 of the end piece 117, said ring being fixed to the wall thereof by a broadened anterior portion 141 having an outside diameter substantially equal to the inside diameter of the bore 133 of the end piece 117.

The ring can be secured, for example, by being pressed in hot or simply by force. The ring 140 is therefore fixed to the end piece 117 for conjoint rotation and translation therewith.

The broadened anterior portion 141 of the ring 140 is extended rearwards by a tubular portion 142 having a smaller cross section, which can be introduced into the skirt 132 of the sleeve 130 and slide therein counter to the action of the spring 126. At rest, the portion 142 is situated outside the skirt 132 (FIG. 4).

Still with reference to FIG. 3, the two temple parts 115, 117 are both mounted on the same intermediate core 146. This core comprises two small cylindrical end barrels 147, 148 which are connected by a central tubular part 149 having a diameter that is narrowed compared with that of the two barrels. The barrel 147 is mounted in the main template part 115. Said barrel is fixed at least in translation with respect to the main temple part. In practice, said barrel will also be rotationally fixed, the core being, for example, force-fitted in this main temple part. The barrel 148 is mounted so as to rotate freely in the end piece 117. The end piece 117, at the anterior end thereof, comprises a transverse annular rim 150, which enters inside the bore 133 of the end piece 117 and which is engaged in the annular space between the two barrels 147, 148 of the core 146. It is by virtue of the resilience of the end piece 117 that the rim 150 has been able to pass the barrel 148 of the core 146. The core 146 thus serves as a translational stop for the end piece 117.

A small separation 160 is provided between the main temple part 115 and the end piece 117, which separation is therefore kept small and constant by means of the core 146.

The slide 123 passes through the core 160, the ring 140 and the spring 126.

The end piece 117 is therefore mounted so as to be able to rotate with respect to the main temple part 115, while remaining separated from each other by a small and constant clearance 160, in order to adjust the tension of the spring 126.

When the wearer of the frame turns the end piece 117, the sleeve 130 turns therewith, for example in order to be screwed onto the slide 123. Then the sleeve 130, through the skirt 132 thereof, comes to be fitted on the ring 140, which is immobilised in translation by the core 146, while turning about said ring, compressing the spring 126. Naturally, by unscrewing the sleeve on the slide 123, the spring 126 expands.

In the embodiment shown in FIG. 5, the sleeve 230 comprises two lateral grooves 236, 237, which are diametrically opposed and extend parallel to the axis of said sleeve. The ring 240, which is here also rotationally fixed in the end piece and in abutment against the core 246, comprises two lateral ribs 243, 244, which are diametrically opposed and extend parallel to the axis of said ring. The two ribs on the ring are engaged in the two grooves in the sleeve. The spring 226 still extends between the bottom of the bore which is formed in the sleeve 230 and the posterior face of the tubular part 242 having the smallest diameter of the ring 240.

When the operator turns the end piece and therefore also the sleeve 230, for example in order to screw said sleeve onto the threaded slide 223, the sleeve 230 approaches the broadened portion 241 of the ring 240, sliding on the tubular part 242 having the smallest diameter and the ribs 243, 244, sliding in the grooves 236, 237, in order to compress the spring 226.

In the variant shown in FIG. 6, the slide 323 no longer passes through a single spring but extends between two adjustment springs 327, 328 that are in abutment not against an annular sleeve bottom but against two bottoms of a stud 329 having two arms 330, 331 in abutment against a pusher 332 which is screwed onto the slide 323 and set into rotation with the end piece (not shown). The remainder of the components of the temple are similar to those in the other embodiments shown in FIGS. 3 to 5, the functioning remaining identical.

1. Spectacle frame comprising a front face (1) which is extended by two lateral lugs (4, 5), and two temples (2, 15) which are each articulated on the lugs about articulation spindles (11) of two telescopic hinges (20) to a front face element (21) which is rigidly connected to a lug and a temple element (22) which is rigidly connected to a temple (15), the temple element (22) of a hinge comprising a slide (123) which is articulated on the front face element (21) and mounted so as to slide in a sheath (125) counter to and under the action of a spring (126), the slide (123) of a temple hinge (20) extending as far as the free end of the tubular temple (15) and housing said sheath (125), a sleeve (130), mounted on the slide (123), being slidably mounted in the end of the temple, in which end said spring (126) also extends so as to cooperate with the sleeve (130), characterised by the fact that the temple is produced in two separate parts, a main part (115) and an end part which forms an end piece (117) in which the spring (126) is arranged, the slide (123) extending into the end piece (117) which is mounted so as to rotate with respect to the main temple part (115) in order to adjust the tension of the spring (126).

2. Frame according to claim 1, wherein the two temple parts (115, 117) are both mounted on the same intermediate core (146) which is fixed in translation with respect to the main temple part (115), in the main temple part (115), the end piece (117) being mounted so as to be able to rotate freely under the core (146) which serves as a translation stop for said end piece.

3. Frame according to claim 2, wherein a ring (140), which is arranged in the end piece (117) to which it is fixed for conjoint rotation and translation, comes into abutment against the core (146), the sleeve (130), which is mounted so as to be able to slide in translation in the end piece (117), also being arranged so as to slide in translation on the ring (146).

4. Frame according to claim 3, wherein the spring (126) is housed in the sleeve (130), in abutment at one end against the bottom of a bore which is formed in the sleeve (130) and, at the other end, against the ring (140), the sleeve (130) and the slide (123) passing through the core (146), the ring (140) and the spring (126) cooperating by screwing.

5. Frame according to claim 3, wherein the sleeve (130) is slidably mounted in the end piece (117) and is arranged so as to slide along at least one groove (136, 137) in the end piece (117).

6. Frame according to claim 3, wherein the sleeve (230) is slidably mounted in the end piece and is arranged so as to slide along at least one rib (243, 244) of the ring (240).

7. Frame according to claim 2, wherein two adjustment springs (327, 328) are provided, which extend on either side of the slide (323).
